(19) United States
(12) Patent Application Publication
(10) Pub. No.: US 2008/0045771 A1
(43) Pub. Date: Feb. 21, 2008

(54) COMPOSITIONS AND DEVICES FOR INACTIVATION OF PHARMACEUTICALS TO FACILITATE WASTE DISPOSAL, AND METHODS THEREOF

(75) Inventor: Peter Regla, Placentia, CA (US)

Correspondence Address: KNOBBE MARTENS OLSON & BEAR LLP, 2040 MAIN STREET, FOURTEENTH FLOOR, IRVINE, CA, 92614, US

(73) Assignee: VESTA MEDICAL, LLC, Irvine, CA (US)

(21) Appl. No.: 11/766,717

(22) Filed: Jun. 21, 2007

Related U.S. Application Data
(63) Continuation of application No. PCT/US05/45970, filed on Dec. 16, 2005.
(60) Provisional application No. 60/639,014, filed on Dec. 22, 2004.

(51) Int. Cl. A62D 3/10

(52) U.S. Cl. 588/301; 588/405

(57) ABSTRACT

The invention relates generally to compositions and devices for the inactivation of pharmaceuticals, such as narcotics, to facilitate waste disposal, and methods thereof. In some aspects, a reaction chamber comprising a fluorescent whitening agent is used to generate hydrogen peroxide in the presence of ultraviolet light. In a preferred embodiment, a stilbene-based fluorescent whitening agent is used. The ensuing chemical reaction inactivates pharmaceuticals, such as narcotics, by cleaving benzene ring structures in some embodiments. The inactivated narcotics can then be disposed of according to conventional medical waste disposal processes, thereby facilitating compliance with both environmental and drug enforcement laws and regulations.

### RELATED APPLICATIONS

This application is a continuation of International Application No. PCT/US2005/045970, filed Dec. 16, 2005, which claims priority to U.S. Provisional Application No. 60/639,014, filed Dec. 22, 2004, all herein incorporated by reference.

### BACKGROUND OF THE INVENTION

1. Field of the Invention

This invention relates generally to compositions and devices for inactivation of pharmaceuticals using, for example, fluorescent whitening agents to facilitate waste disposal, and methods thereof.

2. Description of the Related Art

The use of oxidizers and ultraviolet (UV) light are well-known in the art for breaking benzene rings in waste treatment plants. However, the only processes currently known are designed for large scale waste treatment for use in large factories or treatment plants, where contact with the public is minimized. These processes use ozone, hydrogen peroxide, or UV light, are described below. These processes cannot be adapted for use in hospitals (or other medical facilities) because these use of these processes would be ineffective or dangerous for these healthcare environments.

Ozone (O₃) is one of the strongest oxidizing agents that is readily available. Ozone has been used to reduce color, eliminate organic waste, reduce odor and reduce total organic carbon in water. Ozone is created in a number of different ways, including UV light, corona discharge of electricity through an oxygen stream (including air). In treating small quantities of waste, the UV ozonators are most common, while large-scale systems typically use either corona discharge or other bulk ozone-producing methods. Ozone cannot generally be used in hospitals due to its corrosive effects and possible long term effects on patients and staff. Moreover, high concentrations of ozone cannot be used in hospitals because ozone has been correlated with respiratory illnesses, and are especially dangerous for children and the elderly. High ozone levels are also associated with gastric irritation, acute myocardial infarction, coronary atherosclerosis, and pulmonary heart disease.

Hydrogen Peroxide (H₂O₂) is a strong oxidant commonly used in municipal and industrial wastewater to treat a variety contaminants, such as sulfides, Biological Oxygen Demand (BOD), Chemical Oxygen Demand (COD), cyanide, metals and refractory organics. Increasingly, H₂O₂ technologies are being applied in drinking water treatment. Hydrogen peroxide is attractive for drinking water treatment because it does not form chlorinated byproduct. However, direct sources of hydrogen peroxide cannot be used in the hospital environment for waste treatment. Hydrogen peroxide is caustic and difficult to manage in high concentrations. Hydrogen peroxide is highly reactive to skin, and eyes, and can be fatal in high concentrations. Hydrogen peroxide is a clear, colorless agent that can result in spontaneous combustion when it comes in contact with organic materials. Odor does not provide a warning of hazardous concentrations of hydrogen peroxide. Hydrogen peroxide causes systemic toxicity when inhaled or ingested. Inhalation of vapors, mists, or aerosols from concentrated solutions of hydrogen peroxide can cause significant morbidity, and in some cases, mortality. Technologies that simply use a direct, concentrated, and uncontrolled source of hydrogen peroxide to treat waste cannot be used in hospitals. Yet, hydrogen peroxide is a highly effective oxidizer and is efficient at treating waste. Accordingly, as described below, certain embodiments of the present invention are directed at harnessing the powerful effects of hydrogen peroxide, while minimizing the dangers of using hydrogen peroxide.

Photolysis is the process of chemical decomposition by the action of radiant electromagnetic energy, especially light. Triggered by solar radiation, photolysis removes both nitrous oxide and ozone in the stratosphere. UVA, UVB, and UVC are three recognized wavelength bands of ultraviolet light. According to multiple sources (NASA, FDA, and others) the wavelength regions are: UVA (400 nm-320 nm), UVB (320 nm-290 nm), and UVC (290 nm-100 nm). UV oxidation is a destruction process that oxidizes organic and explosive constituents in wastewater by the addition of strong oxidizers and irradiation with UV light. Oxidation of target contaminants is caused by direct reaction with the oxidizers, UV photolysis, and through the synergistic action of UV light, in combination with ozone (O₃) and/or hydrogen peroxide (H₂O₂). If complete mineralization is achieved, the final products of oxidation are carbon dioxide, water, and salts. The main advantage of UV oxidation is that it is a destruction process, as opposed to air stripping or carbon adsorption, for which contaminants are extracted and concentrated in a separate phase. UV oxidation processes can be configured in batch or continuous flow modes, depending on the throughput under consideration. UV oxidation, generally, is efficient for city waste systems and large factory effluents, but requires a trained staff to operate. The size and power requirements of UV oxidation systems generally prohibit their adaptation for on-site, in-room use in hospitals, pharmacies, or similar facilities. UVC is especially effective for oxidation, but only penetrates clear or light colored liquids. UVC is effective in mildly contaminated water, but has trouble treating dark colored liquids and those with suspended solid particles.

### SUMMARY OF THE INVENTION

Hospital, pharmacies, drug manufacturing plants, and other institutions typically dispose of pharmaceuticals (such as narcotics) by pouring them into the wastewater system. Such disposal methods represent an environmental hazard. Recently, some states have passed laws that limit this practice. One method for limiting wastewater disposal involves containerizing these materials for disposal as hazardous and non-hazardous pharmaceutical waste. However, although this may comply with certain Environmental Protection Agency (“EPA”) and state environmental regulations, the Drug Enforcement Administration (“DEA”) requires that narcotics must first be rendered non-functional and non-recoverable, mainly to prevent their diversion and reuse as recreational drugs. Currently, there are no known methods to provide this function in an institutional setting. Thus, there remains a long standing need for a system that inactivates pharmaceutical waste in a manner that is not only effective, but safe enough for healthcare institutions such as hospitals and pharmacies. Prior art systems that employ high concentrations of straight hydrogen peroxide or ozone do not accomplish this goal.

Accordingly, several embodiments of the present invention provide systems and methods for use in healthcare institutions that render pharmaceuticals (e.g., narcotics, analgesics, etc.) inactive for eventual disposal as hazardous or non-hazardous pharmaceutical medical waste. Some embodiments provide a safe, simple, and cost effective solution for on-site drug disposal processing in a hospital. In preferred embodiments, fluorescent whitening agents (such as stilbene-based agents) are used to inactivate pharmaceuticals. Preferred embodiments of the invention are particularly advantageous because they render narcotics irreversibly inactive, thereby rendering them non-recoverable. This is especially advantageous for those institutions that are required to comply with DEA regulations.

In one embodiment, a system for inactivating an effluent comprising one or more narcotics is provided. In one embodiment, the system comprises a reaction tank comprising an effluent input, an inactivating reactant comprising a fluorescent whitening agent, and an ultraviolet light source to illuminate the reaction tank at a wavelength adapted to produce a reaction that inactivates the narcotic. In one embodiment, the fluorescent whitening agent is stilbene.

In another embodiment, a system for inactivating one or more pharmaceuticals is provided. In one embodiment, the system comprises a reaction tank, an inactivating reactant that releases hydrogen peroxide upon activation of the inactivating reactant by ultraviolet light, a dispenser for dispensing the inactivating reactant into the reaction tank at a controlled rate, a dispenser for dispensing the pharmaceutical into the reaction tank at a controlled rate, a mixer to combine the inactivating reactant and the pharmaceutical in the reaction tank, and an ultraviolet light source to illuminate the reaction tank, wherein the ultraviolet light has a wavelength sufficient to cause the inactivating reactant to release hydrogen peroxide. The pharmaceutical may comprise one or more narcotics, one or more non-narcotics, or a combination thereof. In one embodiment, the inactivating reactant comprises a fluorescent whitening agent. In one embodiment, the inactivating reactant comprises stilbene.

In one embodiment, a system according to any one of the embodiments described herein further comprises a mixer that is adapted to increase the exposure of the contents of the reaction vessel to ultraviolet light, thereby facilitating the inactivation reaction.

In one embodiment, a system according to any one of the embodiments described herein further comprises an inactivating reactant that produces free radicals in a quantity sufficient to cleave one or more benzene rings in the narcotic or pharmaceutical. Free radicals include, but are not limited to, chemicals that are highly reactive and can oxidize other molecules, highly reactive chemicals that attack molecules by capturing electrons thereby modifying chemical structures, highly reactive molecules that have one or more unpaired electrons, and/or atoms or groups of atoms that have an unpaired electron in their outer orbit, causing them to be unstable and highly reactive.

In one embodiment, a system according to any one of the embodiments described herein comprises at least one portion that is disposable.

In another embodiment, the present invention comprises a method for inactivating one or more pharmaceuticals. In one embodiment, the method comprises providing a reaction tank, wherein the reaction tank comprises a stilbene-based fluorescent whitening agent, dispensing a pharmaceutical into the reaction tank, mixing the pharmaceutical with the stilbene-based fluorescent whitening agent, and irradiating the reaction tank with ultraviolet light, thereby inactivating the pharmaceutical. In one embodiment, the pharmaceutical is a narcotic. In another embodiment, the pharmaceutical is a non-narcotic, or a combination of a narcotic and non-narcotic.

In one embodiment, a method according to any one of the embodiments described herein comprises disrupting one or more benzene rings in the pharmaceutical, thereby inactivating the pharmaceutical.

In another embodiment of the present invention a method for inactivating one or more pharmaceuticals by disrupting one or more benzene rings is provided. In one embodiment, the invention comprises combining a fluorescent whitening agent with a pharmaceutical, and irradiating the fluorescent whitening agent and the pharmaceutical with ultraviolet light to produce a chemical reaction, wherein the reaction results in the formation of free radicals, and wherein the free radicals cleave at least one benzene ring in the pharmaceutical, thereby rendering the pharmaceutical inactive. In one embodiment, the pharmaceutical comprises a narcotic. In one embodiment, fluorescent whitening agent comprises a stilbene-based fluorescent whitening agent. In one embodiment, the reaction comprises the formation of hydrogen peroxide.

In yet another embodiment of the present invention, the invention comprises a method for inactivating one or more narcotics. In one embodiment, the method comprises providing a reaction tank, dispensing effluent comprising a narcotic into the reaction tank, dispensing an inactivating reactant into the reaction tank, wherein the inactivating reactant is adapted to inactivate the narcotic, combining the effluent with the inactivating reactant to produce a mixture, irradiating the mixture with ultraviolet light, thereby inactivating at least one narcotic in the effluent, and disposing the effluent. In one embodiment, the narcotic is inactivated by the disruption of one or more benzene rings in the narcotic. In one embodiment, the inactivating reactant comprises a fluorescent whitening agent. In one embodiment, the inactivating reactant comprises stilbene.

In one embodiment, a system or method according to any one of the embodiments described herein further comprises a level sensor to measure the inactivating reactant or the effluent in the reaction tank.

In another embodiment, a system or method according to any one of the embodiments described herein further comprises a reaction tank that is preloaded with an inactivating reactant.

In a further embodiment, a system or method according to any one of the embodiments described herein further comprises a non-fluorescent whitening agent.

In one embodiment, a system or method according to any one of the embodiments described herein further comprises a heat source to increase a reaction rate in the reaction tank or a cooling source to stabilize or decrease a reaction rate in the reaction tank.

In one embodiment, a system or method according to any one of the embodiments described herein further comprises a catalyst to increase a reaction rate in the reaction tank. In one embodiment, the catalyst is heat. In another embodiment, the catalyst is a compound that increases reaction rate. Catalysts include, but are not limited to the non-fluorescent whitening agents described herein.

In another embodiment, a system or method according to any one of the embodiments described herein further comprises an ultraviolet light source produces UVC light. UVA light and/or UVB light may also be used.

In yet another embodiment, a system or method according to any one of the embodiments described herein further comprises a pH meter or other monitoring system to monitor pH in order to, in one embodiment, provide an acidic environment to facilitate the dissolution and/or inactivation of certain pharmaceuticals, particularly those in solid form Neutral and basic environments may also be used for certain types of pharmaceuticals.

In one embodiment, a system or method according to any one of the embodiments described herein is adapted for use in a hospital, pharmacy, or other healthcare or research institutions in which the use of hydrogen peroxide must be controlled or limited.

Several embodiments of the invention render narcotics (and other pharmaceuticals) irreversibly inactive and non-recoverable, which is advantageous for those institutions that are required to comply with DEA regulations.

### BRIEF DESCRIPTION OF THE DRAWINGS

FIG. 1 shows a system for inactivating pharmaceuticals, including a reaction tank, according to one embodiment of the invention.

FIG. 2 shows a system for inactivating pharmaceuticals, including a reaction tank, a reactant dispenser to dispense one or more reactants into the reaction tank, and a pharmaceutical dispenser, according to one embodiment of the invention.

FIG. 3 shows a system for inactivating pharmaceuticals, including a reaction tank and other components, according to one embodiment of the invention.

FIG. 4 shows a system for inactivating pharmaceuticals, including dispensers and a UV light housing, according to one embodiment of the invention.

FIG. 5 shows a system for inactivating pharmaceuticals, including a reaction vessel and an exit port for disposing of inactivated pharmaceutical waste, according to one embodiment of the invention.

FIG. 6 shows a system for inactivating pharmaceuticals, including a reaction tank and other components, according to an alternative embodiment of the invention.

FIG. 7 shows a cross-section of a system for inactivating pharmaceuticals, including a reaction tank and other components, according to one embodiment of the invention.

FIG. 8 shows a flow-chart illustrating a proposed sequence of inactivating waste according to one embodiment of the invention.

### DETAILED DESCRIPTION OF THE PREFERRED EMBODIMENTS

The term “pharmaceutical,” as used herein, shall be given its ordinary meaning and shall include, but not be limited to, analgesics, antihistamines, antidepressants and narcotics.

The term “narcotic,” as used herein, shall be given its ordinary meaning and shall include drugs (e.g., heroin, codeine, methadone) that are derived from the opium poppy plant, contain opium, or are produced synthetically and have opium-like effects. Narcotics shall also include narcotic analgesics.

The terms “renders inactive” or “inactivates” as used herein, shall be given their ordinary meaning and shall include makes non-functional, reduces functionality, makes inert, makes completely inactive, makes substantially inactive, and/or reduces activity to some degree.

The term “fluorescent whitening agent” as used herein shall be given its ordinary meaning and shall also include, but not be limited to, colorless to weakly colored organic compounds that in solution or applied to a substrate absorb ultraviolet light and re-emit most of the absorbed energy as blue fluorescent light between about 400 nm to about 500 nm. Fluorescent whitening agents include, but are not limited to, chemical groups having the characteristic of absorbing visible light, usually due to the presence of long alternating sequences of double and single carbon-carbon bonds (e.g., chromophores) and optical brighteners. Fluorescent whitening agents also include, but are not limited to, agents that are based on the stilbene, coumarin and pyrazoline structures. Examples of fluorescent whitening agents include, but are not limited to, distyryl biphenyls.

The term “stilbene-based fluorescent whitening agent” shall mean a fluorescent whitening agent that comprises one or more stilbene molecules. Commercially available stilbene-based fluorescent whitening agents include, but are not limited to, UVITEX® CF (CIBA Specialty Chemicals Corp.), UVITEX® NFW (CIBA Specialty Chemicals Corp.), both available from Ciba-Geigy AG, Basel, Switzerland. See Keith R. Millington, Generation of Superoxide and Hydrogen Peroxide by Exposure of Stilbene-based Fluorescent Whitening Agents to UVA Radiation, First Internet Conference on Photochemistry & Photobiology, Internet journal of Science (1999) <http://www.photobiology.com/v1/Millington/>, the entire teachings of which are hereby expressly incorporated by reference.

The term “mixture” as used herein is a broad term and shall be given its ordinary meaning, and shall also include suspensions, solutions, colloids, and other combinations. Thus, two liquids, when combined or exposed to one another, may be mixed. Thus, a liquid and a solid, when combined or exposed to one another, may be mixed. Two solids, when combined or exposed to one another, may be mixed. Gelatinous and gaseous compositions may also form a mixture. The term “mixing” as used herein shall be giving its ordinary meaning and shall include combining, contacting, integrating, incorporating, and exposing.

In one embodiment, the present invention renders inactive narcotics having a benzene ring in their chemical structure. In some embodiments, the benzene ring provides a flat area (or bonding site) for binding to certain neural receptors of the central nervous system Generally, this binding is responsible for the narcotic effect provided by these chemicals. Although not wishing to be bound by the following theory, it is proposed that removing the flat area (or bonding site) or otherwise altering or disrupting the benzene ring will render a narcotic incapable of binding to neural receptors, thereby rendering them inactive. It is further proposed that the DEA will, based on this theory, determine that all narcotics drugs so processed are rendered inactive. Accordingly, preferred embodiments of the present invention will render narcotics inactive by eliminating, cleaving, oxidizing, or otherwise disrupting the benzene ring, and, as such, will be approved for drug disposal in hospitals and widely accepted by the marketplace. Preferred embodiments of the present invention will also render drugs non-recoverable by inactivating them in a non-reversible manner. Preferred embodiments of the present invention will not only facilitate compliance with the DEA, but will also facilitate compliance with the EPA by providing devices and methods that rehabilitate and preserve the quality of the water and soil.

In one embodiment, the invention alters the benzene ring of narcotic chemical molecules by a process of oxidation, thereby changing their structure from a ring to a carbon chain. This leaves the molecule without a ring for the flat binding area. In one embodiment, a stilbene-based fluorescent whitening agent (a whitener used in many detergents), a chemical bleach, or other oxidizing agent is used in the presence of ultraviolet light to provide the desired chemical action to break or disrupt one or more benzene rings, thereby, rendering the narcotics inactive. In another embodiment, UV light is not used.

In one embodiment, UV light is used in conjunction with or substituted with another agent that activates fluorescent whitening agents. For example, agents described in U.S. Pat. No. 4,670,183 (herein incorporated by reference), such as hydroxyalkyl(meth)acrylats may used. Thus, in one embodiment, the present invention comprises activating a fluorescent whitening agent with an activating amount of a homopolymer of a hydroxyalkyl(meth)acrylate, a copolymer of two or more hydroxyalkyl (meth)acrylates or a copolymer comprising more than 70 weight percent, in polymerized form, of one or more hydroxyalkyl(meth)acrylates. This method can be used with or instead of UV light.

In other embodiments, the invention renders pharmaceuticals inactive by altering the physical or chemical structure of the pharmaceutical. For example, in one embodiment, a fluorescent whitening agent is used to cleave one or more chemical bonds using the free radicals generated by the fluorescent whitening agent reaction described herein. Thus, pharmaceuticals that do not comprise a benzene ring can also be rendered inactive according to one or more embodiments of the present invention. For example, pharmaceuticals comprising one or more aromatic rings or non-ring structures can also rendered inactive according to one or more embodiments of the invention.

Fluorescent whitening agents have a unique reaction when irradiated with UV light in, for example, an aqueous environment. The combination, in some embodiments, generates hydrogen peroxide that is released into the environment to provide superoxides. Stilbene-based fluorescent whitening agents provide this hydrogen peroxide source rapidly and then is consumed by the irradiation itself. Accordingly, in one embodiment, a method of inactivating narcotics comprises generating hydrogen peroxide using a stilbene-based fluorescent whitening agent and UVC in an aqueous environment. In another embodiment, other forms of UV light are used. In one embodiment, two or more different spectrums of ultraviolet light are used. For example, UVA and UVC light can be used, either simultaneously or in a phased approach. In yet another embodiment, a source of hydrogen peroxide other than a stilbene-based fluorescent whitening agent is used. In a further embodiment, a stilbene-based fluorescent whitening agent is used along with one or more oxidizing agents.

Hydrogen peroxide and UV together, form two free hydroxyl radicals (OH) which are potent oxidizing agents.
H₂O₂+UV=>2OH.

The free hydroxyl radicals (OH) are an excited state species characterized by a one-electron deficiency and are therefore extremely unstable. Because of their instability, a free hydroxyl radical tends to react with the first chemical with which it comes in contact. In aqueous media, hydroxyl radicals also tend to completely oxidize dissolved organic contaminants and produce carbon dioxide, water and salts as by products. Accordingly, in one embodiment, a method of inactivating narcotics comprising the generation of free hydroxyl radicals in aqueous media is provided. In other embodiments, non-aqueous media is used.

In some embodiments, a non-fluorescent whitening agent is used instead of a fluorescent whitening agent, or in conjunction with an fluorescent whitening agent. These non-fluorescent whitening agents include compounds that are capable of releasing or creating hydrogen peroxide and/or free radicals. Examples of non-fluorescent whitening agents include, but are not limited to, oxidizers, compositions comprising sodium hydroxide, hydrogen peroxide and benzenesulfonic acid, C10-C16-alkyl derivatives (e.g., commercially available as Clorox-2), and compositions comprising potassium hydroxide (e.g., commercially available as Oxyclean). Although hydrogen peroxide should not be used in hospitals in concentrations required to be the primary inactivating reagent, the use of hydrogen peroxide according to some embodiments of the present invention is safe because it is used in small concentrations, as an adjunct to the fluorescent whitening agent.

In one embodiment, a method for inactivating pharmaceuticals (e.g., narcotics) comprises: (a) adding a narcotic to a reaction chamber; (b) adding a stilbene-based fluorescent whitening agent to the reaction chamber; (c) mixing the sample and the stilbene-based fluorescent whitening agent; and (d) irradiating by UVC light thereby causing the stilbene-based fluorescent whitening agent to release hydrogen peroxide and photolysis of the benzene rings. After UVC irradiation, the sample is no longer of pharmaceutical value and is inactivated. The sample can now be disposed of as hazardous or non-hazardous pharmaceutical medical waste. The terms “reaction chamber” shall be given its ordinary meaning and shall be used interchangeably with “reaction tank,” “reaction container,” and “reaction vessel.”

In another embodiment, a method for inactivating pharmaceuticals (e.g., narcotics) comprises: activating a magnetic stirring system; (b) dispensing the pharmaceuticals into the reaction tank, where the magnetic stirring system mixes the effluent with the stilbene-based fluorescent whitening agent; (c) determining the mixing time required using a level sensor; (d) completing mixing; and (e) irradiating with UV light once the timed mixing process is completed to continue the reaction process. In some embodiments, the system is irradiated before and/or during the mixing process.

In one embodiment, a system for inactivating narcotics is provided. In one embodiment, the system comprises one or more of the following elements: a reaction tank or container; a device for dispensing a stilbene-based fluorescent whitening agent into the tank at a controlled rate; a magnetic stirring device to mix the materials in the reaction tank; a UV light source that produces UVC light to illuminate the reaction tank; and a level sensor to determine the level of reactants in the tank.

In several embodiments, a system or method for inactivating pharmaceuticals comprises using UVA or UVB light. In other embodiments, a system or method for inactivating pharmaceuticals comprises using one or more inactivating reactants. Inactivating reactants may include both fluorescent whitening agents and non-fluorescent whitening agents. In one embodiment, a non-stilbene-based fluorescent whitening agent is used. In yet other embodiments, chemical bleaches, oxidizers, and/or other non-fluorescent whitening agents are used instead of or in conjunction with fluorescent whitening agents. In one embodiment, two or more different fluorescent whitening agents are used. For example, in one embodiment, a stilbene-based fluorescent whitening agent is used with a non-stilbene-based fluorescent whitening agent. In another embodiment, one or more fluorescent whitening agents is used with one or more non-fluorescent whitening agents. The combination of different fluorescent whitening agents, or of fluorescent whitening agents with non-fluorescent whitening agents may produce, in some embodiments, a synergistic effect. In some embodiments, one or more catalysts may also be used to regulate (e.g., quicken or slow) the generation of H₂O₂ or free radicals, or other steps in the reaction.

In one embodiment, a process for inactivating pharmaceuticals comprises exposing the pharmaceutical(s) to an inactivating reactant for a pre-determined time. One of skill in the art will be able to determine the desired time for inactivation for any specific pharmaceutical or combination of pharmaceuticals. Alternatively, the inactivation process may continue until the temperature reaches a certain point. Thus, “run” time can be time dependent, temperature dependent, or both. In other embodiments, the process is stopped based on other characteristics of the reaction. For example, pH may be used to determine when inactivation has been completed or substantially completed. By-products of the process or derivatives/metabolites of the pharmaceuticals may be measured to determine when to stop the inactivation process in some embodiments. In one embodiment, samples are manually or automatically obtained from the reaction tank and assays are performed to determine the degree of inactivation that has occurred. In other embodiments, the absorbance of the sample is measured to determine if the pharmaceuticals have been sufficiently inactivated. Other analytical tools (such as HPLC or other types of chromatography) can also be used to determine the degree orate of inactivation of pharmaceutics. Thus, the run time of the system can be pre-determined, or it may be dynamic in the sense that it is based on the results of sampling during the process.

In one embodiment, one or more controllers to supervise and command all functions is also provided. Different embodiments can have their own controls for allowing narcotics that require disposal (effluent) to enter the reaction tank or container under system control. This fluid management allows for timely replacement of the container and guards against accidental overfilling of the system.

In one embodiment, structures for stilbene-based fluorescent whitening agents include, but are not limited to the following:

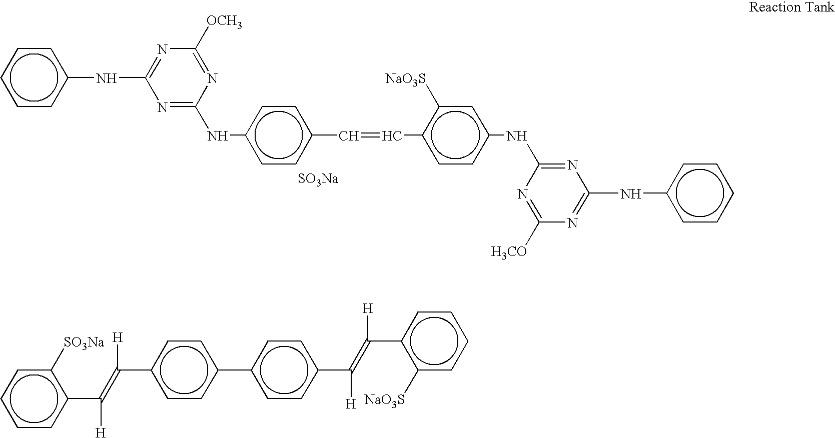

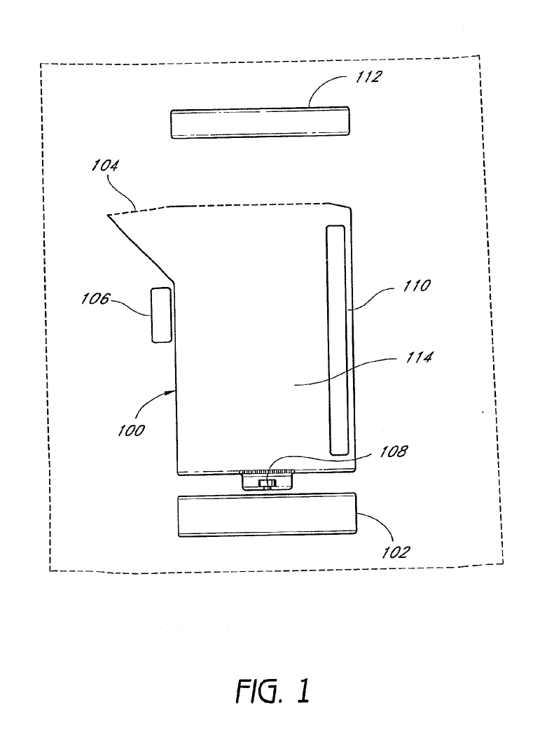

FIG. 1 shows a reaction tank according to one embodiment of the invention. In one embodiment, the reaction tank 100 comprises an effluent input 104, a level sensor 106, and a magnetic stirrer 108 with a magnetic stirrer base 102. A source of stilbene 110 may also be included in the reaction tank 100. The stilbene source 110 may be solid, liquid, gelatinuous, or any other appropriate form. In one embodiment, the stilbene is in powder form. In one embodiment, the reaction tank 100 may be a metal or plastic container with an opening or port 116 for a UV light source 112 to illuminate the mixture 114. In addition, in one embodiment, the reaction tank 100 comprises an alternate port to deposit the pharmaceutical to be processed. In one embodiment, the pharmaceuticals are presented in an aqueous solution to facilitate mixing with a solid state stilbene-based fluorescent whitening agents and other reactants. However, in some embodiments, an aqueous medium is not used.

In one embodiment, the pH of the contents of reaction tank is controlled, either automatically or manually, to ensure an acidic environment. In some embodiments, an acidic environment promotes proper dissolution of pharmaceuticals that are in solid form (e.g., pills, tablets, powders, etc.). Thus, in one embodiment, the pH is adjusted to facilitate dissolution. In some embodiments, the pharmaceutical is a solid, liquid, gas, or some combination thereof.

Although UV light may illuminate the reaction mixture in the reaction tank 100 through one or more ports, in one embodiment, the reaction tank is constructed of a material that will permit UV penetration through the material itself. For example, the reaction tank 100 may be constructed from a translucent or transparent plastic or glass material. In one embodiment, the reaction tank 100 may comprise both opaque portions and portions (such as strips) that permit UV penetration.

In some embodiments, the reaction tank 100 is designed with a small pocket in its floor. This houses the stirring bar 108 for mixing the reactants within the container. In other embodiments, a stirring bar need not be used. Instead, the mixture may be mixed by other mechanical means, electrical means, or sonication. In one embodiment, a mechanical agitator is used. Mechanical agitation includes mixing via motion generated by a mechanic device. Mechanical agitation also includes shaking, stirring, or otherwise agitating reactants. A magnetic stirring bar is one example of mechanical agitation.

In one embodiment, a “single-use” or disposable reaction tank 100 is provided. In one embodiment, one-time reactant dispensers are also installed within the reaction tank 100 to allow all parts that have come into contact with the effluent to be disposed of with the effluent after processing.

In one embodiment, the reaction may be heated or cooled to control the rate of reaction. A cooling source, such as dry ice, a ventilation system, a fan, a heat dissipater, or the like, may be used to stabilize or decrease a reaction time rate in the reaction tank.

Reactant Dispenser

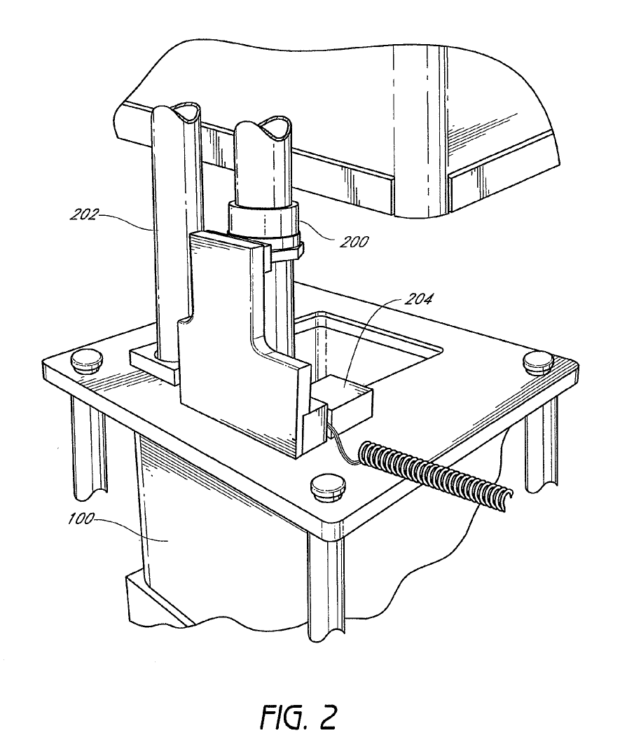

In one embodiment, a method of dispensing a stilbene-based fluorescent whitening agent (or other inactivating reactant or agent) in a controlled manner is provided. As illustrated in FIG. 2, a reactant dispenser 200 to dispense one or more reactants into the reaction tank 100 is provided in one embodiment. In one embodiment, a pharmaceutical waste dispenser 202 is provided for dispensing one or more pharmaceuticals into the reaction tank 100 for inactivation. Some embodiments will use a liquid reactant (such as stilbene) dispensed by a control mechanism 204 (such as a magnetically-actuated valved device) located within the reaction tank 100. In one embodiment, the control mechanism 204 resides outside the reaction tank 100. A small electro-magnet outside the container can energize and causes the valve to open for a specific period of time. The orifice within the calibrated flow rate dispenses the reactant to the effluent.

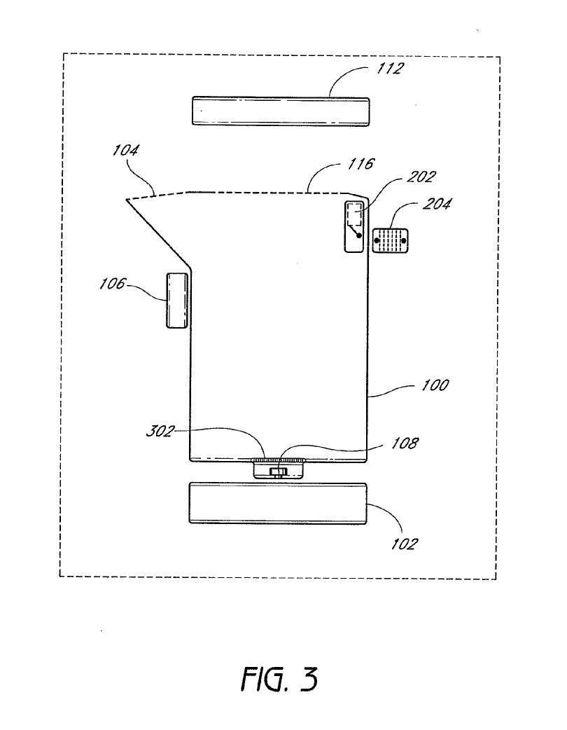

FIG. 3 shows an alternative embodiment comprising a reaction tank 100, a stir bar a pharmaceutical waste dispenser 202. In one embodiment, the reaction tank 100 comprises an effluent input 104, a level sensor 106, and a magnetic stirrer 108 with a magnetic stirrer base 102. In one embodiment, an opening or port 116 for a UV light source 112 to illuminate the mixture 114 is provided. Some embodiments will use a reactant (such as stilbene) dispensed by a control mechanism 204, shown in this FIG. 3 as a magnetically-actuated valved device located outside the reaction tank 100. In one embodiment, a magnetically-actuated valved device is used in conjunction with a magnet 300 located inside the reaction tank 100. In one embodiment, the magnet 300 is a linearly polarized magnet.

In some embodiments, the stilbene-based fluorescent whitening agent is in a solid form, which slowly dissolves into the effluent as the fluid level rises. The fluorescent whitening agent, whether stilbene-based or not, can be a liquid, gel, solid, gas, or combination thereof. The fluorescent whitening agent, whether stilbene-based or not, may be present in a reaction vessel prior to the addition of the pharmaceutical. Alternatively, the fluorescent whitening agent may be added before, during, or after the addition of the pharmaceutical.

Stirring Bar

In some embodiments, a stirring bar 108 and base 102 is used. As shown in FIG. 3, in one embodiment, the stirring bar 108 is held in a cavity at the base of the reaction tank 100 with a cover 302 over it. The cover 302 may be a perforated mesh. The cover 302 allows the bar to spin freely while being held captive to the reaction tank 100. In one embodiment, the entire reaction tank 100 is disposable, including the stirring bar 108. In some embodiments that have a disposable reaction tank 100, all internal components including stirring bar 108 and a stilbene-based fluorescent whitening agent dispensing systems will remain with the reaction tank 100 during the disposal process.

One advantage of a magnetic stirring bar 108 and base 102 is to expose larger and different surface areas to ultraviolet light, thereby allowing the ultraviolet light to penetrate more efficiently and effect a reaction. One of skill in the art will understand that other mixing devices and methods that increase the turbidity, increase the surface area of the mixture, and/or increase exposure to ultraviolet light can be also used according to several embodiments of the invention. For example, the mixture may be mixed by other mechanical means, electrical means, or sonication. In some embodiments, a mixing device is not used.

UV Light Source

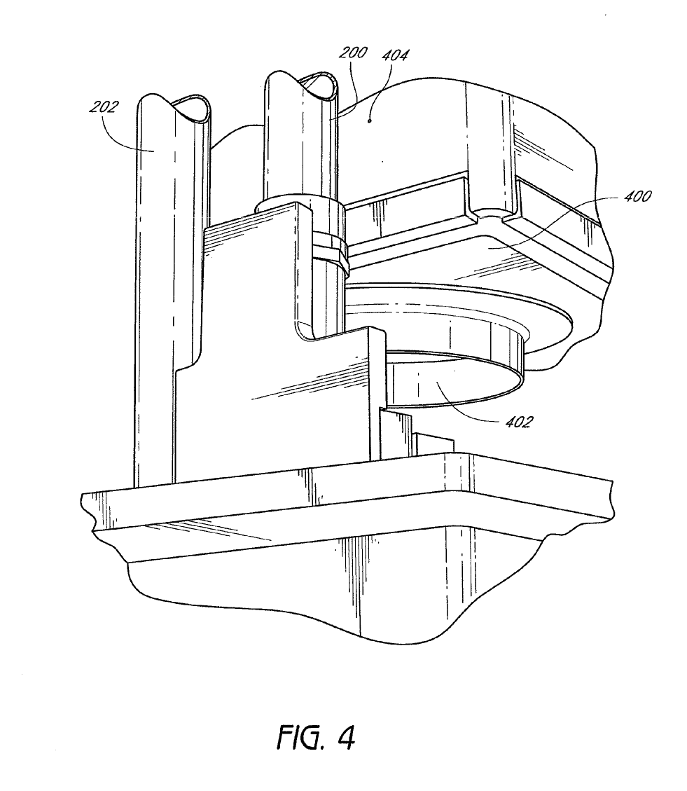

In one embodiment, one or more UV light sources 112 are provided. FIG. 4 shows one embodiment of the UV light source 112. In some embodiments, a UV light source that produces UVC light to illuminate the reaction tank is located outside the container. In one embodiment, the UV light source 112 is partially or fully contained within a UV light source housing 400. In one embodiment, a servo controlled mechanical shutter 402 controls the irradiation of the reaction tank 100, limiting the UVC exposure to the allotted time deemed by controller 402. A UV indicator light 404 can be included to indicate whether the light is on or off. Optionally, a digital UV display can be used to display the wavelength emitted. A timer may be used to control the amount of irradiation. In some embodiments, it may be desirous to irradiate the mixture at different wavelengths at different times. This may be accomplished by including a notification system or alarm to notify a user to change the wavelength. Or, this may be accomplished by an automated system. For example, the user may pre-set the system such that irradiation is provided for 20 minutes at 200 nm, 30 minutes at 240 nm, and 10 minutes at 270 nm. The system may also be set up to deliver UVA, UVB, and UVC light simultaneously or in sequence.

In one embodiment, the light source produces ultraviolet light in the range of about 190 nm to about 280 nm. This provides the wavelengths for photolysis of most chemical components in an aqueous solution.

Also shown is FIG. 4 is a reactant dispenser 200 and a waste dispenser 202. As discussed above, the reactant may be a fluorescent whitening agents, such as a stilbene-based agent. When two or more fluorescent whitening agents are used, they can be delivered simultaneously or sequentially.

In one embodiment, the combination of a stilbene-based fluorescent whitening agent and UV light generates hydrogen peroxide. Hydrogen peroxide alone, or the combination of the hydrogen peroxide and UV light are effective in inactivating certain pharmaceuticals. For example, a study performed with aspirin and hydrogen peroxide showed that as the concentration of hydrogen peroxide (available from Fisher Scientific) in the reaction vessel was increased, the concentration of aspirin (salicylic acid, available from Fisher Scientific) in the vessel decreased. The results (conduct on behalf of the Applicant) showed that hydrogen peroxide was effective in inactivating aspirin, a compound that has aromatic rings.

| Hydrogen peroxide concentration | Salicylic acid concentration |
|---|---|
| 0 | 16.8 mg/dl |
| 0.75% | 10.7 mg/dl |
| 1.5% | 6.5 mg/dl |
| 2.25% | 3.7 mg/dl |
| 3.0% | 2.6 mg/dl |

In other studies conduct on behalf of the Applicant, the effects of using sodium hypochlorite was also tested. Sodium hypochlorite is useful for inactivating certain pharmaceuticals. For example, using bleach in concentrations from 0.133% to about 0.535% sodium hypochlorite yielded concentrations of less than about 2 mg/dl of salicylic acid.

The use of hydrogen peroxide in combination with UV light provides a synergistic effect. For example, the prior art used ultraviolet light, ozone, and hydrogen peroxide to oxidize dissolved organic contaminants in groundwater or wastewater. See U.S. Pat. Nos. 4,849,114 and 4,792,407, both herein incorporated by reference.

Thus, hydrogen peroxide alone, or in combination with ultraviolet light are effective in treating waste. However, as discussed above, direct or uncontrolled sources of hydrogen peroxide cannot be used in sensitive environments (such as hospitals, pharmacies, and other healthcare institutions) because of the dangers associated with hydrogen peroxide exposure. Thus, in some embodiments of the present invention, a stable controlled source of hydrogen peroxide is used to inactivate pharmaceuticals. For example, in one embodiment, stilbene is used as a particularly good source of stable controllable hydrogen peroxide because the release of hydrogen peroxide can be controlled by manipulating the amount of ultraviolet light exposure. Thus, the system will only generate an amount of hydrogen peroxide that can be used up substantially immediately by the wastes in the system. There is little or no excess hydrogen peroxide, and thus the dangers that are normally associated with hydrogen peroxide are minimized or eliminated.

Level Sensor

In one embodiment, one or more level sensors 106 are provided. The level sensor 106, in one embodiment, determines the level of reactants in the tank. In one embodiment, the level sensor 106 is located outside the tank. In another embodiments, the level sensor 106 is located outside the tank and permanently installed in the system support structure, thereby managing the fluid level within the tank.

In conjunction with the controller module included in some embodiments, processing times can be calculated and reactant dispensing rates determined. In one embodiment, the level sensor communicates with the controller and calculates when the reaction tank is full and cannot take additional effluent from the operator. The level sensor can also determine when to open the appropriate valves for draining the processed effluent into the disposal tank for waste disposal. The level sensor can also aides other tasks, such as reaction timing and reactant dispensing.

The types of level sensors that can be used in accordance with preferred embodiments of the present invention include, but are not limited to, the sensors disclosed in Applicant's U.S. Publication No. 20050119909, herein incorporated by reference.

For example, in some embodiments, it is desirable to measure a fill level of waste within the reaction tank. In some embodiments, such fill level sensing can be performed by measuring a weight of tank, such as by using a load cell, balance, or other weight measurement device. In further embodiments, float systems can be adapted for use in determining a level of a waste material in the tank. In some cases, it is also desirable to perform such fill level measurements without the sensor physically contacting the tank or the tank contents.

In some embodiments, a piezo transducer can be used to determine a volume of air remaining in the tank by conducting a frequency sweep of the transducer to determine the resonance of the air in the tank. Once the volume of air in the tank is known, the air volume can be subtracted from the known total tank volume to obtain the volume occupied by the tank contents. In another alternative embodiment, a distance-measuring sensor (such as SONAR, RADAR or optical distance-measuring sensors) can be located above and directed through the opening of the tank in order to determine a “height” of the tank contents. Still other embodiments may use optical sensors to measure a fill level of a tank.

In one embodiment, a level sensor automatically determines a fill level of the tank using an optical method. In one embodiment of a fill level sensing system, the system comprises a light source and a light detector positioned on opposite sides of a reaction tank. In alternative embodiments, the light detector is not be located immediately opposite the light source. For example, in some embodiments the detector can be located on a wall adjacent to the source. In one embodiment, the sensor system generally operates on the principle that an “empty” tank will permit more light to pass from the source, through the tank, and to the sensor than will a “full” tank. This is simply due to the fact that the contents of the tank will absorb and/or reflect a substantial portion of the light which enters the tank from a light source. As used herein, the terms “empty” and “full” shall be given their ordinary meaning and shall be used to define relative amounts of debris, reactants, or other matter, in a tank. For example, in certain embodiments, the sensor may indicate that the tank is ready to be emptied or discarded, not because it is completely saturated, but because it has reached the desired point of fill or saturation.

In alternative embodiments, a parameter other than weight or filled volume may be used to determine when a tank is “full.” For example, in one embodiment, a sensor to detect radioactivity is used to determine the amount of radioisotope in a tank or receptacle. The radioactivity sensor may used in connection with a fill sensor, or it may be used alone. Thus, in some embodiments, a tank may be emptied, discarded, or replaced based on a certain amount of radioactivity, rather than (or in addition to) the surface area, volume, weight, density and/or another parameter of the material in that tank.

In yet another embodiment, a sorting and disposal system can be provided without any automatic level detection apparatus. For example, in such an embodiment, the tanks can be configured to allow a clinician, maintenance person, or other user to visually verify a fill level of the tank. In such embodiments, the tanks can be made of a substantially transparent or translucent material. Alternatively, the tanks may be substantially opaque but can include a transparent viewing window to allow visual verification of a fill level. Such viewing windows could extend substantially an entire height of the tank, or could extend only a height of a desired portion of the tank.

Since the level sensor 106 can be a non-contact device, the container can be disposed of without replacing this unit. Thus, in some embodiments, the level sensor 106 is reusable. In some embodiments, however, the level sensor 106 is disposable.

Exit Port

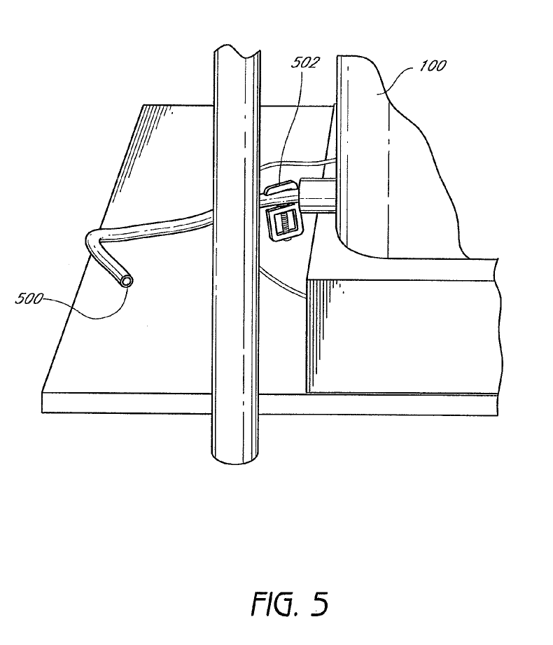

In one embodiment, one or more exit ports are provided. FIG. 5 shows one embodiment of a system comprising an exit port 500. As shown, the processed fluid exit port 500 is located at the lower left hand corner of the cabinet. The exit port may be located at any appropriate location. In one embodiment, a fluid exit system comprises a surgical rubber tube, a hose clamp 502 and an exit port 500 at the base of the reaction tank 100. In one embodiment, the hose clamp 502 provides a simple valving method to empty the processed fluid out of the reaction tank.

In one embodiment, the processed fluid (or other matter) is emptied via a regular drainage system. This embodiment works particularly well if the processed material is no longer a hazardous material pursuant to EPA and DEA regulations. In other embodiments, the processed materials are channeled into a holding tank so that the material can be “red-bagged” and disposed of as medical waste. The medical waste disposal may be relatively facile because the narcotics are no longer “drugs” and thus are harmless from a DEA standpoint.

In some embodiments, the exit port is used to facilitate sampling of the reactants in the tank. In one embodiment, the exit point 500 is situated to facilitate the sampling of effluent (or processed waste) to ensure that the pharmaceutical waste has reached the desired amount of inactivation. A sampling port can be used instead of or in addition to the exit port to provide a measurable test quantity for assay. In some embodiments, commercially available drug screening assays can be used to sample the contents of the reaction tank for sufficient inactivation. For example, a test such as the 10-Drug Test Panel (DP-952, available from BTNX.com) would be able to test for amphetamines, barbiturates, benzodiazepines, marijuana, cocaine, methadone, methamphetamine, opiates, phencyclidine, and tricyclic antidepressants in liquids.

In many embodiments, the entire reaction container 100 including processed effluent, reactants, stirring bar, and internal dispensing systems will be disposable as a single unit. Therefore, in one embodiment, there will not be a need for the exit port.

System For Inactivating Pharmaceuticals

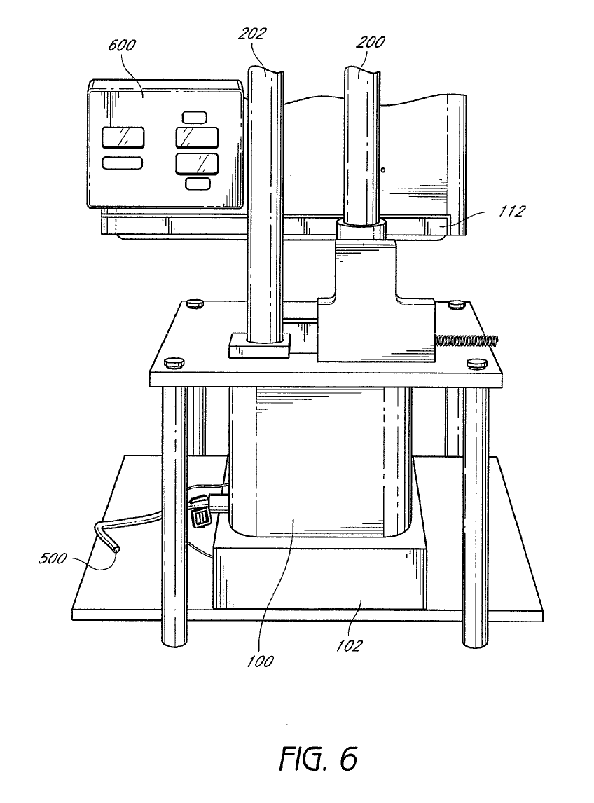

In one embodiment of the invention, as shown in FIG. 6, a system for inactivating pharmaceuticals comprises a reaction tank 100, a UV light source 112, and a reactant (e.g., stilbene) dispenser 200. Optionally, a temperature readout 600 is provided to monitor the temperature of the mixture or reaction tank 100. A pharmaceutical waste dispenser 202 may be provided to facilitate disposal of the waste into the reaction tank 100. The waste and the reactant (e.g., stilbene) may be mixed using a magnetic stirring bar 108 (not shown) in conjunction with a magnetic stirrer base 102. Once the pharmaceutical waste has been inactivated, a processed fluid exit port 500 may be provided to facilitate removal of the processed material.

The temperature readout 600 may show several temperatures. For example, the temperature within the UV light box, the reaction tank, the system cabinet, and/or the mixture may be provided on the temperature readout 600.

In one embodiment, a temperature sensor is provided to determine the temperature of the UV source. Mounted in the UV light source, or in communication with the light source, the sensor communicates the temperature of the UV bulb to the processor. In one embodiment, the UV source may be sensitive to temperature. For example, as the temperature rises above 90 degrees F., there is may be shift from UVC towards UVB light. The resonating bond frequency for aromatics is UVC and particularly 180-200 nm. Thus, in one embodiment, the temperature sensor is used to monitor the temperature of the UV bulb in order to control the wavelength.

In one embodiment, a temperature sensor is provided to determine the temperature of the exothermic oxidation process that occurs in the reaction tank. In one embodiment, the temperature will rise as oxidation begins and will continue to rise as the reaction peaks. Thus, the curve reflects the reaction's progress. As the temperature wanes, additional reactant (e.g., stilbene) can be added. If the temperature does not rise even after additional reactant is added, the reaction can be deemed complete. Temperatures may reach 140° F. in certain organics.

In one embodiment, a temperature sensor is provided to determine ambient temperature as a baseline for referencing the other sensors.

In one embodiment, a processor links the temperature sensors and/or data together with an algorithm using the current level from the level sensor and the previous level of the tank, to determine the run time of the process. This determines when the process is complete.

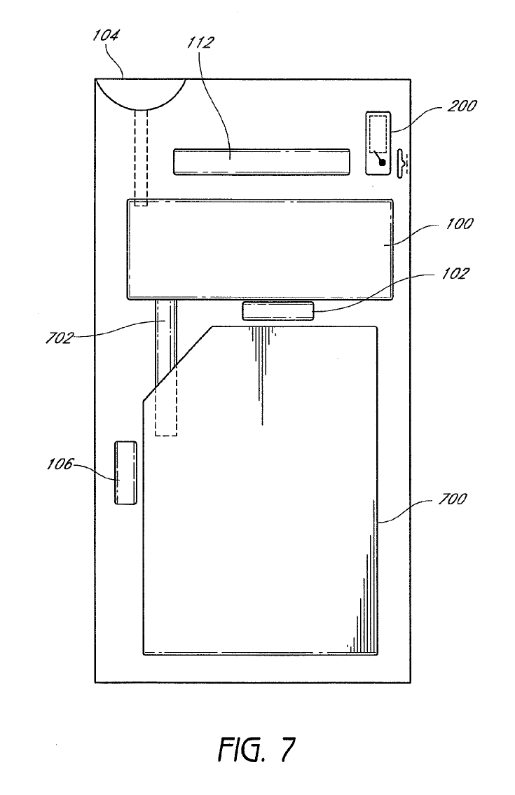

FIG. 7 shows a cross-section of a system for inactivating pharmaceuticals. In one embodiment, the system comprises a reaction tank 100 (e.g., a removable container which may or may not be a single use disposable vessel) and a UV light source 112. The system can also comprise one or more reactant dispensers 200, one or more waste (or effluent) input ports 104, and one or more level sensors 106. A magnetic stirrer 108 (not shown) with a magnetic stirrer base 102 may also be provided. In one embodiment, as illustrated here in one aspect, a disposal or holding tank 700 is provided for containing the processed waste. In some embodiments, an effluent output 702 (such as a tubing, pipe, or other drainage system) is provided from the reaction tank to the disposal or holding tank 700. Drainage from one tank to the other can be accomplished by gravitational pull, vacuum, or other means. In other embodiments, the reaction tank and the disposal tank are one and the same, with the stirring bar inside the one tank. At disposal time, in one embodiment, the disposal tank with the stirring bar, is removed from the UV light source and stirring motor base and capped. The disposal tank may then taken to a red bag area with the processed fluids still inside for proper disposal. Alternatively, as shown in FIG. 7, the reaction tank and the tank designed to hold the processed materials are different. In this embodiment, the disposal tank can feed to a drainage system, or it can be removable so that a user can dispose of the entire disposal tank at a proper disposal site, while the reaction tank remains stationary and/or reusable.

The following Examples illustrate some embodiments of the present invention and are not intended in any way to limit the invention.

### EXAMPLE 1

In one embodiment, a system for inactivating pharmaceuticals comprises a system that is contained, partially or fully, within a housing. In one embodiment, the housing is a modular metal cabinet approximately 2 feet cubed. A small microprocessor based controller is mounted at the side of the cabinet to allow easy interface to the operator. The software, discussed infra, is resident in the controller. An external interface to another computer simulates a central data bank, according to some embodiments.

In one embodiment, the common components of the system reside behind a tinted glass door. In this embodiment, the glass door provides for visual monitoring of the system in operation while blocking stray UV light. Authorized full access is permitted via the keylock door. In several embodiments, these common components are housed in a secure structure. Therefore, in one embodiment, direct viewing of the components is not possible while in operation.

In one embodiment, two tubes protrude from the top of the system cabinet. These allow effluent samples as well as a stilbene-based fluorescent whitening agent (liquid, solid, or gel), and/or other reactive agents, to be added to the system, without accessing the internal structure. These tubes are covered by removable metal caps to minimize dirt and other contaminates from entering the reaction chamber.

In one embodiment, the controller is a microprocessor based system that oversees all aspects of the processing function. In other embodiments, the controller will also oversee communications to a central data system, providing on-site data collection functions as well as access control.

In one embodiment, the controller has a small LCD readout (status display) that shows the sequence of events as they occur. Three buttons below the status display provide user control. The LCD provides prompting for these buttons.

In one embodiment, at the base of the controller's housing is a communication port for external computers/networks to oversee operations and modify system parameters. It is also used to simulate proposed interaction described in other embodiments, including waste pharmaceutical tracking and data logging with the assistance of a central data bank.

In one embodiment, with the glass door open, the internal structure of the prototype can be seen clearly. The components may vary in other embodiments and may comprise one or more of the following: a reaction tank, a temperature readout module, a sample dispensing system, a processed fluid exit port, a UV light source and a magnetic stirrer base.

In one embodiment, the reaction tank is a rectangular metal tank with an insulated covering to control thermal changes within the system A Peltier cooler is attached to the rear of the tank to provide further thermal control if experiments require it. The temperature readout module is located at the upper left corner of the cabinet. Three independent thermal probes are used to measure critical temperature. In an alternative embodiment, temperature monitors and read-outs are not required.

In one embodiment, one probe is housed in the UV lamp housing. UV lamps can vary their wavelength depending on the temperature of their environment. As temperature rises, their wavelength lengthens. Since the inactivation processes use a stable wavelength in some embodiments, the previously discussed controller has a background task of forced cooling the UV housing as this temperature module dictates. Another temperature probe is located at the sample tank. Attached directly to a thermal well in the tank, the temperature of the reactants can be measured and recorded. If needed, the tank thermal control can be linked to this probe to stabilize the temperature to provide a constant experimental environment. A probe can also be located in the temperature readout module itself to provide an ambient reading of the interior of the cabinet.

In one embodiment, the sample dispensing system is located in the center of the cabinet. It is mounted on the support structure which covers the top of the reaction tank. Two tubes as previously described, protruding from the top of the cabinet, meet here. One tube (labeled “sample”) allows measured effluent sample to be poured into the reaction tank directly from outside the cabinet. The other tube allows a stilbene-based fluorescent whitening agents to be stored. At the base of this tube is a servo-controlled valve with an auger cup to measure out controlled allotments of reactants. As mentioned previously, other reactants are useful in place of a stilbene-based fluorescent whitening agents for other embodiments.

In one embodiment, the servo-controlled valve is monitored and actuated by the previously discussed controller. Each actuation dispenses a given amount of the reactant. Therefore, multiple actuations provide a way to vary the allotment on each test run. The processed fluid exit port is located at the lower left hand corner of the cabinet. It is composed of a surgical rubber tube, a hose clamp and an exit point at the base of the reaction tank. The exit point is located so that a minimal sample of effluent can be used to provide a measurable test quantity for assay. The hose clamp provides a simple valving method to empty the processed fluid out of the reaction tank.

In one embodiment, the processed fluid exit port tubing is supported by a removable twist clasp so that it can be positioned for easy filling of sample tubes and flasks. The surgical tubing provides additional flexibility here.

In many embodiments, the entire reaction container including its processed effluent, reactants, stirring bar, and internal dispensing systems will be disposable as a single unit. Therefore, in one embodiment, there will not be a need for the exit port.

In one embodiment, the UV light source is located at the center top of the cabinet. Inside the large gray box is a grid shaped UV mercury lamp. Flanked on both sides of the light box are fans that blow air into the cabinet via controller commands. As mentioned previously, thermal readings from the temperature readout module are monitored by the controller which commands the fans to hold the light box's temperature within limits.

In one embodiment, a servo controlled mechanical shutter controls the irradiation of the tank, limiting the UVC exposure to the allotted time deemed by controller.

In one embodiment, the UV light source has a large power supply at the rear of the cabinet which is not shown in this illustration. It provides the required high voltage for the UV lamp. The UV lamp has an external indicator which glows green when the lamp is on. The indicator is directly illuminated by the lamp source and converts the UVC to a visible light via fluorescence. It does not allow any UVC to pass, making it directly viewable by the human eye. Further, in some embodiments, this indicator is linked to a sensor to regulate the light source via the controller or external control.

In one embodiment, the magnetic stirrer base is located at the base of the reaction tank. It houses the mechanics for the stirring process. Using a magnetic stirring process allows the stirring function to be isolated to an area inside the reaction tank. This is advantageous for some embodiments because the stirring bar is disposable with the reaction container in some of the systems. In one embodiment, the magnetic stirrer base is magnetically linked to a magnetic stirring bar located within the reaction tank. It mixes the reactants under the actuation of the magnetic stirrer base. In some embodiments, the magnetic stirring bar is disposable with the tank or container. In some embodiments, the magnetic stirring bar is located in a depression or cavity covered by a perforated cover. This allows the bar to be retained in the cavity during shipping or storage. This concept allows proper alignment with the magnetic components of the stirrer base. The perforated cover allows the reactants to interact with the bar while in motion. One advantage of a magnetic stirrer is to expose larger and different surface areas to ultraviolet light, thereby allowing ultraviolet light to penetrate and effect a reaction. One of skill in the art will understand that other mixing devices and methods that increase the turbidity, increase the surface area of the mixture, and/or increase exposure to ultraviolet light can be used according to several embodiments of the invention.

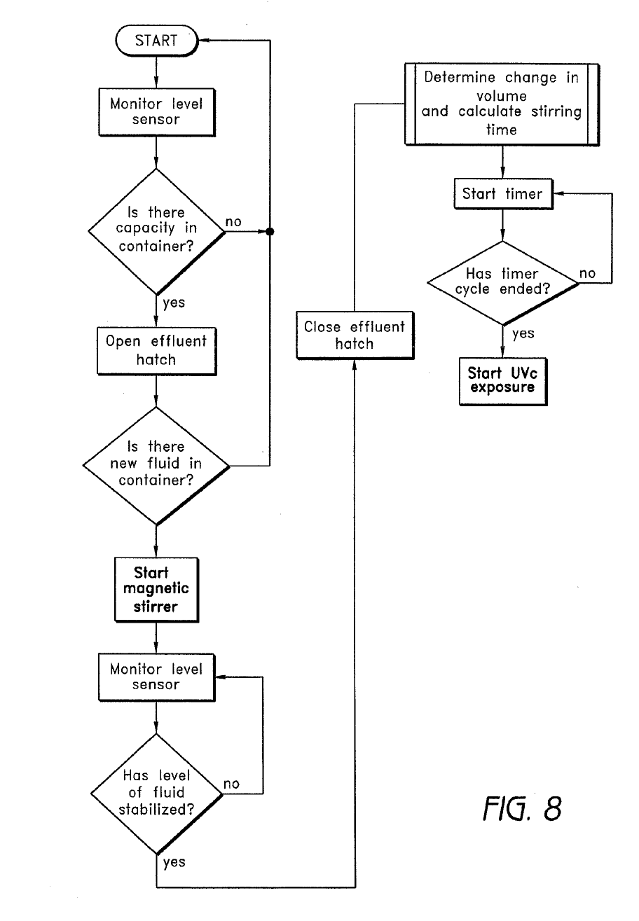

In one embodiment, software is used to control several aspects of the system. Based in a microprocessor, the software controls both mechanical and sensor functions of the prototype system. The program begins at “start.” This start command varies in some embodiments. For example, a bar scanner can be used by the operator to begin the program. Here the specifics of the effluent are known and are transferred to the software for timing references. In other embodiments, a simple operator-actuated button is used. While in other embodiments, a combination of readouts, verbal commands, and buttons are used to sequence the process along. One example of a processor sequence is illustrated in FIG. 8. FIG. 8 shows a drug processor sequence of events. However, not all events need be present in any one embodiment. One or more of the events shown in FIG. 8 are present in some embodiments of the present invention. Moreover, the events need not be present in the sequence identified in FIG. 8.

As shown in FIG. 8, in one embodiment, the program begins at “start”. The first task is to monitor the level sensor located near the reaction tank or container. Based on this reading, the program determines if the tank has capacity for additional fluid. If the reading is satisfactory, the program allows the effluent hatch to open. If it is determined that insufficient capacity exists, the program will halt and an error code will be issued. The program will then restart, after the container is emptied. If the reading is satisfactory, the program continues, allowing the effluent hatch to open. Using the baseline reading from the level sensor, the program continues to monitor the level sensor to determine value changes from the stored baseline value. New fluid entering the container is detected by the level sensor and the motion information passed onto the microprocessor. The program signals the magnetic stirrer system to actuate. If no fluid is detected, the program resets to start. To simplify the flow diagram, the functions of resetting are not explained here. Error checking and timeout checks are performed in this resetting event to guard against unexpected closures.

In one embodiment, with the magnetic stirrer system actuated, the program monitors the level sensor again to determine when the fluid level has stabilized, as evidenced by multiple readings with little deviation. In some embodiments, additional input from the operator or other sensors may add additional safeguards. When fluid level is stabilized, the program actuates the effluent hatch to close. Again, some embodiments have additional operator-assist functions required to close the hatch. For example, fluid level displays and status indicators are used to alert the operator of pending functions like opening/closing the effluent hatch. For simplicity, the “close effluent hatch” summarizes these alternate functions.

In one embodiment, with the effluent hatch closed, the program now branches to calculating the stirring time that will be needed to mix the previous contents with the new fluid that has been added in the last “hatch opening.” This step is critical as it determines the time needed to dissolve sufficient a stilbene-based fluorescent whitening agent into the mix for proper reaction levels to be reached before irradiation with UVC. In some embodiments, a liquid stilbene-based material is substituted for the solid form discussed here. In a liquid-type embodiment, several additional steps are included to dispense a measured quantity of reactant to the mix. The microprocessor controls these additional functions through this calculation.

In one embodiment, with the calculated stirring time determined, the program sets a timer and begins checking for a timeout condition. During this stirring period, the device continues mixing a stilbene-based fluorescent whitening agent (or other reactants) with the effluent. Other reactants may be used in place of stilbene-based materials for other embodiments.

In one embodiment, when the timeout is reached, the UV light source irradiates the mixture, while stirring continues. Stirring during irradiation allows even irradiation of the mixture, with the goal of obtaining a complete, homogenous reaction.

In one embodiment, with irradiation and mixing underway, the program determines the irradiation time needed for full reaction. When the irradiation timer reaches its allotted time, the program branches to the completion functions of its cycle. A signal is sent to stop both the UV light source and the magnetic stirring system. This completes the processing cycle and the program returns to the start point, awaiting the next new effluent sample.

### EXAMPLE 2

In one embodiment, the solid stilbene-based compound (or other reactant) is replaced with a liquid form. When liquid stilbene-based fluorescent whitening agents (or other reactants) are used, externally actuated dispensers are provided in some embodiments. In one embodiment, an electromagnet is mounted near the disposable container's wall, near the position of the internal storage of liquid. Inside the internal liquid storage unit is a vessel for the stilbene-based liquid or other reactant to be dispensed. A pinch tube or other valving system holds this liquid in the vessel until commanded to release. The release mechanism is a magnet or is a device that is ferric in nature, allowing a magnetic field of close proximity to actuate. The electromagnet, external to the disposal container, is commanded by the controller to produce a magnetic pulse of specific duration. This magnetic pulse is transmitted through the container wall, to actuate the valving system of the dispenser for a given period of time. The orifice on the valving system is calibrated for the viscosity of the liquid so that the length of magnetic pulse is directly proportional to liquid dispensed. The remaining components of this scenario are similar to designs previously discussed.

### EXAMPLE 3

In one embodiment, a system based on a permanent system installation where many of the components are not disposable is provided. In one embodiment, the reaction tank is permanently mounted in the equipment housing. The stirring bar mechanism can be other than the previously discussed magnetic design. For example, the mixture may be mixed by other mechanical means, electrical means, or sonication. A special valve is added to hold the processed effluent in this tank, until it can be disposed of or drained into a disposable container below. The level sensor takes on a different task than previously described. Here, the sensor or sensors notes the presence of a disposable container for draining the reaction tank as well as the level of effluent in the reaction tank. Communicating with the controller, the level sensor calculates when the reaction tank is full and cannot take additional effluent from the operator as well as when to open the appropriate valves for draining the processed effluent into the disposal container for waste disposal. The level sensor also aides the other tasks, such reaction timing and reactant dispensing, discussed previously. A liquid reactant dispenser with a disposable storage container is used for dispensing the reactant (stilbene-based or other) into the reaction tank. Here, the valving maybe more conventional but the liquid reactant storage is disposable.

In one embodiment, a mechanism is also installed with the reaction tank that allows it to only partially drain into the disposable container below. This allows sufficient fluid to remain for the next batch of unprocessed effluent to allow for a successful processing cycle. Since only the operator knows and controls the amount to be deposited, retention of a known quantity of fluid in the reaction tank is critical to a successful processing cycle.

### EXAMPLE 4

In one embodiment, a system for inactivating pharmaceuticals using a stilbene-based fluorescent whitening agent is provided. As described by Keith R. Millington, <http://www.photobiology.com/v1/Millington/>, earlier work on wool fabrics treated with stilbene-based fluorescent whitening agents and then exposed to ultraviolet light (sunlight) demonstrated that ultraviolet light in the presence of an aqueous solution (water) releases hydrogen peroxide and causes discoloration of the wool.

Thus, according to one embodiment of the present invention, a stilbene-based fluorescent whitening agent will be used to produce hydrogen peroxide in a controlled and safe manner by using an aqueous media and ultraviolet light. The controlled release of hydrogen peroxide will render pharmaceutical waste (such as narcotics) inactive. For example, two commercial water soluble fluorescent whitening agents (such as Uvitex CF and/or Uvitex NFW) will be obtained in concentrated powdered form and recrystallised from aqueous ethanol before use.

One or more fluorescent whitening agents will be irradiated with ultraviolet light adapted to produce UVA, UVB, or UVC light (or a combination thereof). The lamp will be cooled using a fan or other cooling means, and the temperature of the solution during irradiation will be kept below about 30° C. The method for producing hydrogen peroxide from stilbene using ultraviolet light will be adapted from Millington, above. In other embodiments, the temperature is maintained at a range of about 30° C. to about 70° C. In other embodiments, the temperature is varied to control reaction rate.

In one example, aqueous solutions (0.01% w/v) of one or more fluorescent whitening agents will be mixed with one or more narcotics and irradiated for brief periods up to 10 minutes. In other embodiments, shorter irradiation times will be used. In still other embodiments, periods greater than 10 minutes will be used (e.g., hour periods, or longer). Because the temperature of the solutions is expected to increase rapidly through the course of the experiment, shorter periods of irradiation may be advantageous in certain embodiments. After irradiation for a period of time, the sample is analyzed for the presence of narcotics using a commercially available drug screening assay. In some embodiments, the concentration of the fluorescent whitening agent will be that which produces hydrogen peroxide in approximately a 1:1 molar ratio with the pharmaceuticals to be treated.

In one embodiment, if desired, a catalyse such as superoxide dismutase (250 units/ml) will be added to the reaction tank and combined with the fluorescent whitening agents and the narcotics prior to irradiation or during irradiation. This may produce higher levels of hydrogen peroxide for irradiation periods of 30 minutes or more, and may be desirable in certain situations.

From the foregoing description, it should now be appreciated that a novel approach for the inactivation of pharmaceutical and medical waste has been disclosed. While the invention has been described with reference to specific embodiment, the description is illustrative of the invention and is not to be construed as limiting the invention. Various modifications and applications may occur to those who are skilled in the art, without departing from the true spirit and scope of the invention, as described by the appended claims.

What is claimed is:

1. A method for inactivating a narcotic, comprising:
providing a reaction tank comprising an aqueous medium;
combining a stilbene-based fluorescent whitening agent with a narcotic in said reaction tank, wherein said narcotic comprises a benzene ring; and
irradiating said fluorescent whitening agent and said narcotic with ultraviolet light to produce hydrogen peroxide,
wherein said hydrogen peroxide produces a free hydroxyl radical in the presence of said ultraviolet light,
wherein said hydrogen peroxide is consumed during the irradiation process, and
wherein said free hydroxyl radical cleaves at least one benzene ring in said narcotic, thereby rendering said narcotic inactive.

2. The method of claim 1, further comprising acidifying the aqueous medium to facilitate dissolution or inactivation of said narcotic.

3. The method of claim 1, further comprising providing a mixer to increase the exposure of the contents of the reaction vessel to ultraviolet light, thereby facilitating the inactivation of the narcotic.

4. The method of claim 1, further comprising:
dispensing said narcotic into said reaction tank at a controlled rate;
dispensing said fluorescent whitening agent into said reaction tank at a controlled rate; and
mixing to combine said inactivating reactant and said pharmaceutical in said reaction tank; and
an ultraviolet light source to illuminate said reaction tank, wherein said ultraviolet light has a wavelength sufficient to cause the inactivating reactant to release hydrogen peroxide.

5. The method of claim 1, further comprising providing a level sensor to measure the contents in said reaction tank.

6. The method of claim 1, further comprising providing a heat source to increase a reaction rate in the reaction tank.

7. The method of claim 1, further comprising providing a cooling source to stabilize or decrease a reaction rate in the reaction tank.

8. The method of claim 1, further comprising providing a catalyst to increase a reaction rate in the reaction tank.

9. The method of claim 1, wherein the ultraviolet light is UVC light.

10. A system for inactivating a narcotic, comprising:
a reaction tank comprising an aqueous medium;
a stilbene-based fluorescent whitening agent that releases hydrogen peroxide upon irradiation by ultraviolet light;
a dispenser for dispensing said stilbene-based fluorescent whitening agent into said reaction tank at a controlled rate;
a dispenser for dispensing a narcotic into said reaction tank at a controlled rate;
a mixer to combine said stilbene-based fluorescent whitening agent and said narcotic in said reaction tank; and
an ultraviolet light source to illuminate said reaction tank, wherein said ultraviolet light has a wavelength sufficient to cause the stilbene-based fluorescent whitening agent to release hydrogen peroxide.

11. The system of claim 10, further comprising a level sensor to measure the level of contents in the reaction tank.

12. The system of claim 10, wherein said reaction tank is preloaded with said stilbene-based fluorescent whitening agent.

13. The system of claim 10, further comprising a heat source to increase a reaction rate in the reaction tank or a cooling source to stabilize or decrease a reaction rate in the reaction tank.

14. The system of claim 10, further comprising a catalyst to increase a reaction rate in the reaction tank.

15. The system of claim 10, wherein at least a portion of said system is disposable.

16. The system of claim 10, wherein said mixer is adapted to increase the exposure of the contents of at least one of the narcotic or the stilbene-based fluorescent whitening agent to the ultraviolet light, thereby facilitating the inactivation of the narcotic.
